(19) United States
(12) Patent Application Publication
(10) Pub. No.: US 2026/0236311 A1
(43) Pub. Date: Aug. 13, 2026

(54) EVENT-DRIVEN ORCHESTRATION SYSTEMS AND METHODS FOR CLOUD-BASED JOB EXECUTION

(71) Applicant: FMR LLC, Boston, MA (US)

(72) Inventors: Pooja Wadhwa, Bengaluru (IN); Nitin Madaan, Bengaluru (IN); Arun Chand Balakrishnan, Garner, NC (US); Venkata Krishna Prasanth Mukthevi, Bengaluru (IN); Shivaraj Matiwade, Bangalore (IN); Manish Gupta, Milford, CT (US); Suraj Kumar, Bengaluru (IN); . Abhishek, Bengaluru (IN)

(21) Appl. No.: 19/530,657

(22) Filed: Feb. 5, 2026

Related U.S. Application Data
(60) Provisional application No. 63/757,511, filed on Feb. 12, 2025.

(51) Int. Cl. G06F 9/50; G06F 9/54

(52) U.S. Cl. CPC G06F 9/5038; G06F 9/5055; G06F 9/542

(57) ABSTRACT

Systems and methods for an orchestrating process for executing jobs based on cloud events include a cloud platform that generates an event notification and transmits the event notification to an event orchestration system, which stores the event notification in an event notification database. The event orchestration system determines one or more jobs and one or more processing rules that correspond to the event notification. After executing the one or more processing rules, the orchestration system transmits the event notification that is retrieved from the event notification database to trigger execution of the job on a workflow processing system.

### RELATED APPLICATIONS

This application claims priority to U.S. Provisional Patent Application No. 63/757,511, filed February 12, 2025, the entirety of which is incorporated herein by reference.

### TECHNICAL FIELD

This application relates generally to computing systems and methods, including computer program products, for event-driven orchestration and execution of jobs in distributed cloud computing environments.

### BACKGROUND

Many software applications require synchronization of data to maintain consistency across distributed computing systems and devices. Examples include operating system updates, academic record management systems, and large-scale social media platforms in which user data, content, or state information is replicated across multiple servers and client devices. In conventional architectures, such synchronization is performed across geographically distributed servers to ensure that each server maintains an identical and up-to-date representation of shared data before that data is propagated to end-user devices.

In existing systems, data synchronization is typically performed during predetermined time windows (for example, during overnight hours) to reduce the likelihood of contention with active users and other system workloads. This approach is driven by technical limitations of conventional synchronization mechanisms, which often require repeated processing of large data sets, substantial compute and memory resources, and long execution times. Because these synchronization processes are highly sensitive to interruption—such as network failures, process restarts, or partial execution—any disruption can result in inconsistent system state, corrupted data, or failed transactions. As a result, conventional systems rely on isolated execution windows to minimize interference and reduce the risk of synchronization failure.

While time-based synchronization reduces certain failure risks, it introduces significant technical drawbacks. Specifically, delayed synchronization prevents systems from reflecting real-time state changes, increases system latency, and limits scalability in environments where data updates occur continuously. Moreover, traditional synchronization techniques lack mechanisms to safely process discrete, non-replayable events as they occur, particularly in distributed cloud environments where execution is asynchronous and failure-prone. Consequently, existing approaches are ill-suited for providing reliable, instantaneous synchronization without risking race conditions, inconsistent execution ordering, or partial system failure. There is therefore a need for computing systems that can perform real-time synchronization in a technically reliable manner while preserving correctness, determinism, and fault isolation across distributed computing resources.

### SUMMARY

In contrast to conventional data synchronization techniques that rely on predetermined execution windows, batch processing, and interruption-sensitive workflows, the disclosed systems and methods provide a technical architecture for orchestrating job execution in response to discrete, non-replayable events generated by a cloud platform. The systems and methods capture each event notification as a durable, machine-readable record and applies rule-driven execution logic that enforces deterministic ordering, explicit execution state transitions, and fault isolation across distributed computing resources. By executing jobs within isolated, ephemeral compute instances and coordinating execution through persisted rule records rather than time-based synchronization windows, the disclosed system enables real-time processing while avoiding race conditions, inconsistent state, and partial execution failures that characterize conventional synchronization approaches.

In some embodiments, execution of a job is governed by one or more machine-readable processing rules associated with the job, including serial, parallel, and bulk processing rules that define how and when execution is permitted to occur. Serial processing rules enforce deterministic execution ordering based on rule dependencies and event metadata, while parallel processing rules permit immediate execution when dependency conditions are satisfied. Bulk processing rules coordinate execution of multiple jobs within a shared compute instance according to defined scheduling criteria. Rule evaluation is performed through persisted rule records that track execution state transitions, enabling the system to coordinate concurrent event notifications, suppress duplicate execution, and manage failure conditions without reliance on global synchronization windows. In this manner, the system provides controlled, real-time orchestration across distributed computing resources while preserving correctness, consistency, and fault isolation.

In further embodiments, each job is executed within a compute instance that is generated specifically for the job and instantiated without shared persistent state, thereby isolating execution from other concurrently running jobs. The compute instance is terminated immediately upon completion of the job execution, which releases allocated compute, memory, and network resources and prevents residual state from influencing subsequent executions. By coupling event-driven orchestration with ephemeral, isolated compute instances and persisted execution state, the system provides predictable execution semantics and bounded resource usage in distributed cloud environments, enabling reliable real-time operation without sacrificing system stability or scalability.

The invention, in one aspect, features a computing system for orchestrating jobs on a cloud platform. The system includes a server computing device with a memory for storing computer-executable instructions and a processor that executes the computer-executable instructions. The server computing device captures an event notification that is transmitted by the cloud platform after a specific event has occurred in the cloud platform. The event notification is stored in an event notification database after being captured, the event notification is non-replayable and generated a single time by the cloud platform, and the event notification includes event notification metadata. The server computing device determines a job corresponding to the event notification and one or more processing rules associated with the job based on the event notification metadata. The one or more processing rules determine a manner in which to execute the job, and the one or more processing rules include one or more processing actions that are performed before and after execution of the job. The server computing device executes the one or more processing rules by evaluating machine-readable rule records that define execution dependencies and execution state transitions for the job. The server computing device triggers the job for execution, after determining that each of the one or more processing rules has been successfully executed, by retrieving the event notification metadata from the event notification database. The server computing device executes the job on a compute instance that is generated specifically for the job, the compute instance being instantiated without shared persistent state and isolated from other compute instances, wherein the compute instance is terminated immediately after completion of the job execution to release compute resources and prevent cross-job interference.

The invention in another aspect, features a computerized method of orchestrating jobs on a cloud platform. A server computing device captures an event notification that is transmitted by the cloud platform after a specific event has occurred in the cloud platform. The event notification is stored in an event notification database after being captured, the event notification is non-replayable and generated a single time by the cloud platform, and the event notification includes event notification metadata. The server computing device determines a job corresponding to the event notification and one or more processing rules associated with the job based on the event notification metadata. The one or more processing rules determine a manner in which to execute the job, and the one or more processing rules includes one or more processing actions that are performed before and after execution of the job. The server computing device executes the one or more processing rules by evaluating machine-readable rule records that define execution dependencies and execution state transitions for the job. The server computing device triggers the job for execution, after determining that each of the one or more processing rules has been successfully executed, by retrieving the event notification metadata from the event notification database. The server computing device executes the job on a compute instance that is generated specifically for the job, the compute instance being instantiated without shared persistent state and isolated from other compute instances, wherein the compute instance is terminated immediately after completion of the job execution to release compute resources and prevent cross-job interference.

Any of the above aspects can include one or more of the following features. In some embodiments, execution of the job comprises processing one or more incoming data, and wherein the job includes one or more processing actions that process the one or more incoming data. In some embodiments, the one or more processing rules associated with the job include at least one of: (i) an encryption processing rule that causes at least one of the one or more incoming data to be encrypted, and (ii) a decryption processing rule that causes at least one of the one or more incoming data to be decrypted. In some embodiments, the one or more processing rules associated with the job include a serial processing rule that determines whether the one or more incoming data has successfully been processed by one or more previous jobs that are scheduled to execute before the job, and the serial processing rule is successfully executed after determining that the one or more previous jobs have successfully processed the one or more incoming data. In some embodiments, each of the one or more incoming data is associated with a timestamp, and when the one or more processing rules include the serial processing rule, each of the one or more incoming data is sequentially processed by the job according to the timestamp.

In some embodiments, the one or more processing rules associated with the job include a parallel processing rule that causes the job to be executed immediately after retrieval of the event notification metadata from the event notification database. In some embodiments, the one or more processing rules associated with the job include a bulk processing rule that causes the job to be scheduled to execute simultaneously with one or more other jobs that each correspond to the bulk processing rule, and the job and the one or more other jobs are executed within a same compute instance. In some embodiments, the bulk processing rule causes jobs to be processed at predetermined time intervals.

In some embodiments, the one or more processing rules associated with the job include a transmission processing rule that causes the job data processed by the job to be transmitted to a specific destination after the job has been successfully executed. In some embodiments, the server computing device detects and suppresses duplicate event notifications corresponding to a same cloud event using the event notification database. In some embodiments, the server computing devices marks the event notification as completed in the event notification database after the job has successfully been executed. In some embodiments, the server computing device performs the execution state transitions defined by the machine-readable rule records atomically to prevent inconsistent job execution states.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for an orchestration process for executing jobs based on cloud events.

FIG. 2 is a system flow diagram for an orchestration process for executing jobs based on cloud events.

FIG. 3 is a flow diagram of a computerized method for processing cloud events.

FIG. 4 is an example diagram illustrating a table of multiple processing rules.

FIG. 5 is an example diagram illustrating an architecture for an orchestration process for executing jobs based on cloud events.

FIGS. 6A-6C are flow diagrams of a computerized method for processing a serial rule.

FIG. 7 is a diagram of an illustrative computing system.

### DETAILED DESCRIPTION

In the following description, embodiments of the disclosed system and methods are described with reference to the accompanying drawings, which illustrate representative implementations of the invention. Specific terminology is used for clarity and descriptive purposes; however, the disclosure is not intended to be limited to the particular terms or examples described. Rather, each described component, feature, or operation is intended to encompass technical equivalents that perform similar functions or achieve similar results.

Certain well-known functions, configurations, and operations of computing systems are not described in detail where such description would obscure the technical aspects of the disclosed embodiments. Additionally, various tools, modules, or components are described herein as illustrative mechanisms for implementing the disclosed functionality. It should be understood that such mechanisms may be implemented in software, hardware, firmware, or combinations thereof, and may be integrated, distributed, or otherwise arranged in different configurations without departing from the scope of the disclosure.

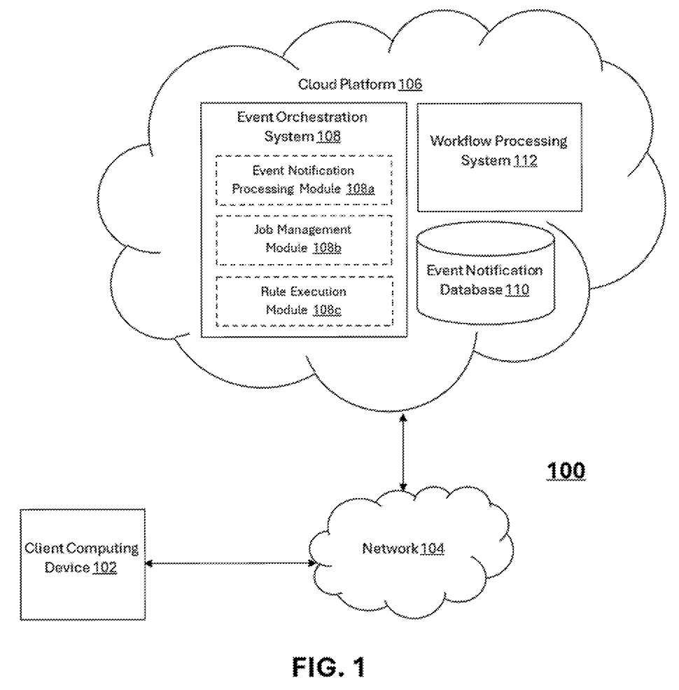

FIG. 1 is a block diagram of a system 100 for an orchestration process for executing jobs based on events. System 100 includes a client computing device 102 and a cloud platform 106, all of which are capable of communicating with each other via communication network 104.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website, which can be reached by entering a uniform resource locator (URL). Exemplary client computing devices 102 include, but are not limited to, desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The cloud platform 106 may include a cloud infrastructure, in which one or more server computing devices cooperate with each other (e.g., in the form of sharing resources) to provide one or more services (e.g., storage, executing applications). In some embodiments, each server computing device of the cloud platform 106 may include specialized hardware and/or software modules that execute on a processor and interact with memory modules of each server computing device, to transmit data to (or receive data from) other components of the server computing device, other server computing devices, or other devices in the system 100, as described herein. In some embodiments, the cloud platform 106 may be a container orchestration system. In some embodiments, the container orchestration system may be implemented using an infrastructure provided by Kubernetes™.

In some embodiments, the server computing devices of the cloud platform 106 may communicate (via a substrate network) as if they existed in a local area network (LAN) environment. For example, the server computing devices may share a common subnet, and (from the perspective of the devices) directly communicate with one another without the use of complex routing protocols. In another example, unlike traditional LANs, the devices within the cloud need not share a direct physical interconnection. Instead, the devices may be located in geographically diverse regions, and in some instances may themselves be virtual devices (e.g., virtual machines). A substrate (e.g., physical) network may encapsulate or otherwise alter communications from devices associated with the cloud platform 106 to create the illusion, from the point of view of the server computing devices within the cloud platform 106, that a LAN environment exists. Cloud platforms provide many advantages over traditional LANs, in that the configuration of the server computing devices can be changed dynamically, via software, without changing a physical configuration of the server computing devices. Moreover, the cloud platform 106 maintains many traditional benefits of LANs in that communications between the computing devices are relatively simple and secure.

In some embodiments, a single data center may include sufficient hardware to implement multiple cloud platforms, each of which may be isolated from each other (e.g., each cloud platform may include a separate substrate network). For example, the cloud platform 106 may be a virtual private cloud (VPC), which is a private cloud computing environment that is isolated from other users on a public cloud platform (e.g., a public cloud platform may include the cloud platform 106 and one or more other cloud platforms). The isolation may be accomplished by creating a separate network environment for each VPC. In contrast, a public cloud platform may provide shared resources (e.g., storage, networking, etc.) among multiple users. Such resources can be accessed by anyone with an internet connection.

The cloud platform 106 includes several systems, frameworks, stores, and computing modules that execute on one or more processors of the each server computing device in the cloud platform 106. For example, the cloud platform 106 includes an event orchestration system 108, an event notification database, and a workflow processing system 112. The event orchestration system 108 includes an event notification processing module 108a, a job management module 108b, and a rule execution module 108c. In some embodiments, the event notification processing module 108a, the job management module 108b, and the rule execution module 108c are specialized sets of computer software instructions programmed onto one or more dedicated processors in one or more server computing devices of the cloud platform 106 and can include specifically-designated memory locations and/or registers for executing the specialized computer software instructions.

In some embodiments, the event orchestration system 108 may be divided into two or more components (e.g., computing modules), in which each component may be included in a different server computing device of the cloud platform 106. In such case, the server computing devices that include event orchestration system 108 may cooperate with each other to execute the services provided by the event orchestration system 108. Likewise, in some embodiments, the workflow processing system 112 may be divided into two or more components (e.g., computing modules), in which each component may be included in a different server computing device of the cloud platform 106. In such case, the server computing devices that include the workflow processing system 112 may cooperate with each other to execute the services provided by the workflow processing system 112. Similarly, the event notification database 110 may be divided into two or more components (e.g., computing modules), in which each component may be included in a different server computing device of the cloud platform 106. In such case, the server computing devices that include event notification database 110 may cooperate with each other to execute the services provided by the event notification database 110.

Although the event notification processing module 108a, the job management module 108b, and the rule execution module 108c may execute within different server computing devices of the cloud platform 106, in some embodiments the functionality of the event notification processing module 108a, the job management module 108b, and the rule execution module 108c can be performed in a single computing device. Further, as shown in FIG. 1, cloud platform 106 allows the event notification processing module 108a, the job management module 108b, and the rule execution module 108c to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the event notification processing module 108a, the job management module 108b, and the rule execution module 108c are described in detail below.

The event notification database 110 is a computing device (or, in some embodiments, a set of computing devices) that is configured to provide, receive and store various data associated with access control. The event notification database 110 may store one or more event notifications that are received (or captured) by the event orchestration system 108. The event notifications may include an event, which may be, for example, a structured message that indicates changes in resources. In some embodiments, an event can be a create, read, update, or delete (CRUD) operation. In other embodiments, an event can be at least one of a resource lifecycle state change, a system event, and a system event impacting a resource. In further embodiments, the event notifications may be associated with one or more event types, such as, but not limited to, object created, instance launched, database connection failed, etc.

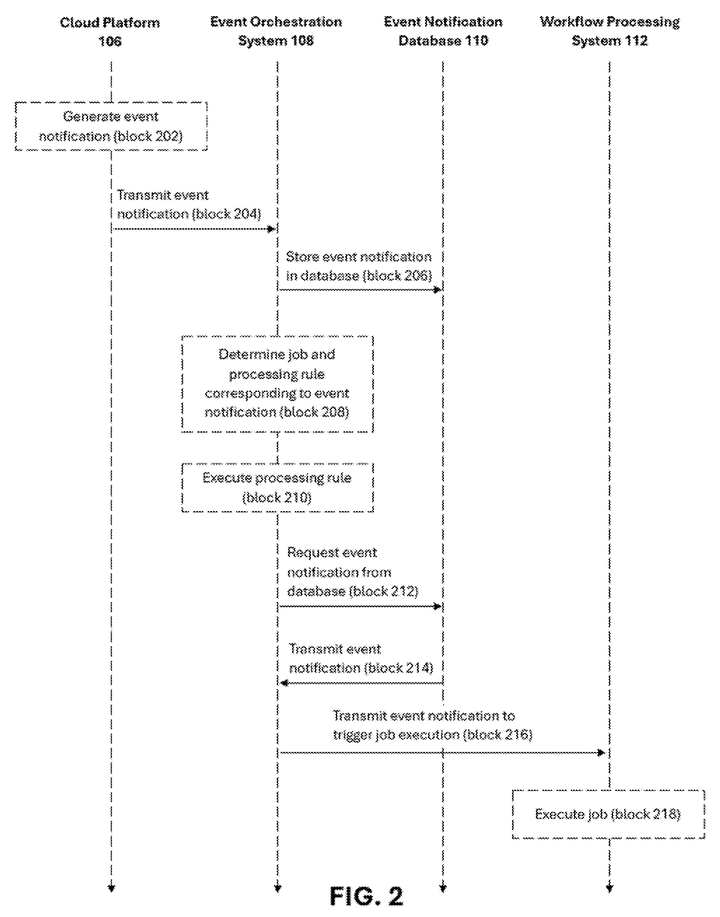

FIG. 2 illustrates an exemplary flow diagram corresponding to the system 100 of FIG. 1, in which the cloud platform 106, event orchestration system 108, event notification database 110, and the workflow processing system 112, communicate with each other to perform one or more actions. At block 202, the cloud platform 106 generates an event notification. At block 204, the cloud platform 106 transmits the event notification to the event orchestration system 108. At block 206, the event orchestration system 108 stores the event notification in the event notification database 110. At block 208, the event orchestration system 108 determines one or more jobs and one or more processing rules that correspond to the event notification. At block 210, the event orchestration system 108 executes the one or more processing rules. At block 212, the orchestration system 108 requests the event notification from the event notification database 110. At block 214, the event notification database 110 transmits the event notification to the event orchestration system 108. At block 216, the event orchestration system 108 transmits the event notification trigger job execution of the one or more jobs corresponding to the event notification. At block 218, the workflow processing system 112 executes the one or more jobs.

### Example Routine for Processing Cloud Events

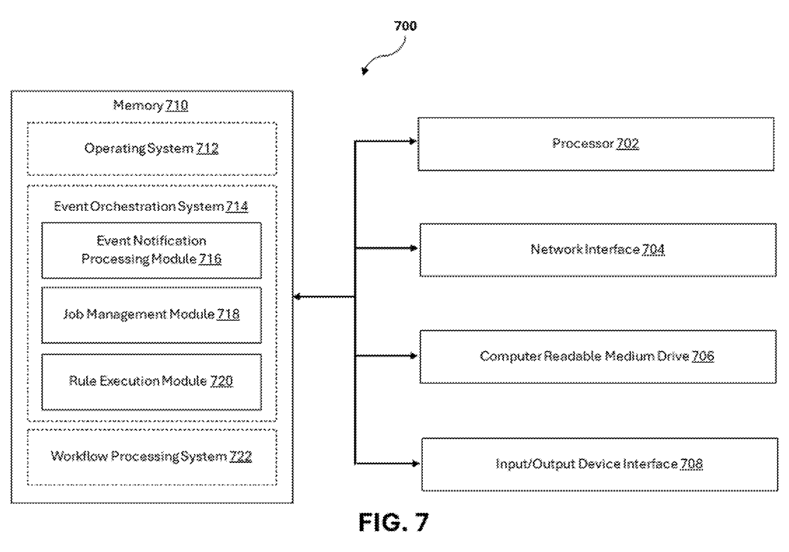

When a routine described herein (i.e., 300 and 600) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 700 shown in FIG. 7, and executed by one or more processors. In some embodiments, the routine 300 and 600, or portions thereof may be implemented on multiple processors, serially or in parallel.

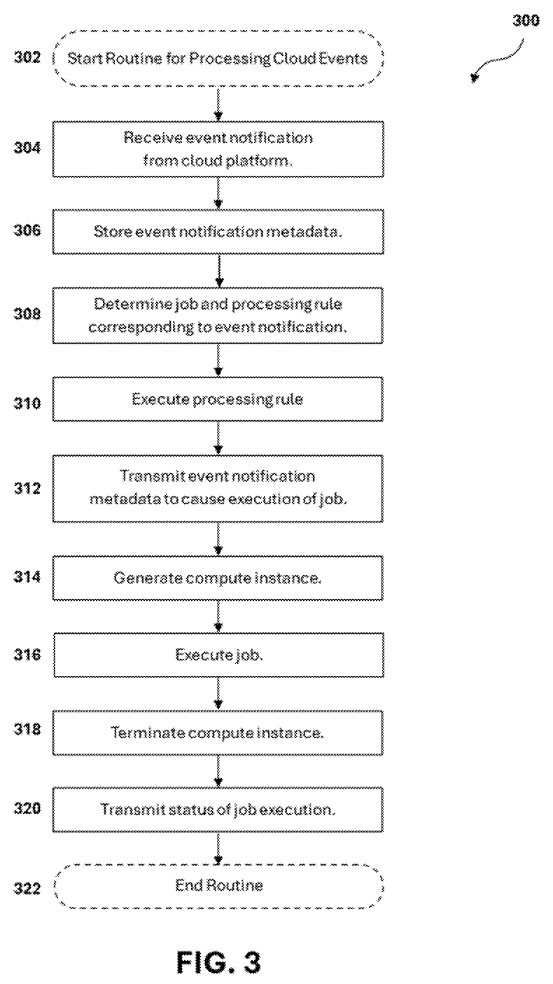

FIG. 3 illustrates example routine 300 (beginning at block 302) for processing cloud events, that is performed, for example, by at least one of the event orchestration system 108, the event notification database 110, and the workflow processing system 112. At block 302, the event orchestration system 108 (or the event notification processing module 108a) may receive an event notification (e.g., cloud event) from the cloud platform 106. As discussed previously, the event notification may include an event, which may be, for example, a structured message that indicates changes in resources. In some embodiments, an event can be a create, read, update, or delete (CRUD) operation (e.g., view or read the social media posts, update total amount of money in user’s bank account due to a transaction performed, etc.). In other embodiments, an event can be at least one of a resource lifecycle state change, a system event, and a system event impacting a resource. In further embodiments, the event notifications may be associated with one or more event types, such as, but not limited to, object created, instance launched, database connection failed, etc.

At block 306, the event notification processing module 108a stores an event notification metadata in the event notification database 110. More specifically, the event notification processing module 108a may extract the event notification metadata from the event notification, and then store the event notification metadata into the event notification database 110. In some embodiments, the event notification processing module 108a may forego extracting the event notification metadata, and store the received event notification into the event notification database 110 instead. In some embodiments, the event notification stored in the event notification database 110 may be marked as pending or “in queue” when the corresponding job has not yet been executed (whether successfully or unsuccessfully). In some embodiments, the event notification stored in the event notification database 110 may be marked as completed (e.g., but the event notification is not deleted or removed from the event notification database 110) when the corresponding job has been executed (whether successfully or unsuccessfully).

It should be noted that, in some embodiments, the event notifications generated (or produced) by the cloud platform 106 may be transmitted only once. In such embodiments, the cloud platform does not guarantee redelivery, replay, or persistence of the event notification after transmission and the event notification becomes irretrievably lost. Failure to capture an event notification may have serious consequences, since it may introduce inconsistencies in the data (e.g., event notification corresponding to banking transaction is not captured, thereby creating discrepancies in banking accounts). Accordingly, the immediate capture and durable storage of the event notification metadata in the event notification database 110 constitutes a technical safeguard against data inconsistency, race conditions, and loss of system state in distributed computing environments.

In some embodiments, multiple event notifications corresponding to a same job or shared data may be received concurrently by the event orchestration system 108. To prevent race conditions and inconsistent execution, the event orchestration system 108 enforces exclusive access to rule records and job execution state during rule evaluation and job triggering.

Such exclusive access may be implemented using one or more concurrency control mechanisms, including but not limited to record-level locking, version checks, atomic compare-and-swap operations, or other synchronization primitives. These mechanisms ensure that only a single compute instance is permitted to transition a given rule record or job execution state at a time, thereby preventing conflicting job executions based on overlapping event notifications.

At block 308, the job management module 108b may determine a job and one or more processing rules corresponding to the event notification. For example, after storing the event notification metadata (or event notification) in the event notification database 110, the event notification processing module 108a may transmit such event notification metadata to the job management module 108b (which determines the job and the one or more processing rules). In some embodiments, the event notification processing module 108a may extract relevant portions of the event notification metadata and transmit such relevant portions to the job management module 108b.

A job may be a unit of work that includes one or more tasks. Such job may be executed by the workflow processing system 112. An example of a workflow processing system 112 is Control-M™ by BMC Software, Inc. More specifically, a job may be typically associated with at least one of instructions and input data (or incoming data), in which the instructions may cause the system or processor to process the input data (or incoming data) according to a specific procedure, thereby generating output data (e.g., such as a change in the system’s state). The workflow processing system 112 may schedule the one or more jobs. More specifically, whenever a job is transmitted to the workflow processing system 112, the workflow processing system 112 may assign a position in a job queue to the job. The assignment of the job may be based on the configuration (e.g., scheduling algorithm) of the job queue (e.g., first in, first out; priority-based; round robin; shortest job first; resource-based; etc.). When the job is ready to be executed according to the job schedule, the workflow processing system 112 may execute (or cause execution of) the job.

After determining the job based on the event notification metadata, the job management module 108b may cause (e.g., trigger) one or more processing rules to be executed. More specifically, the job management module 108b may determine the one or more processing rules that correspond to the job based on at least one of the event notification metadata and a job metadata corresponding to the job. In some embodiments, the job management module 108b may transmit at least one of the event notification metadata and the job metadata to the rule execution module 108c, which then determines which processing rules correspond to the job (e.g., based on the event notification metadata and the job metadata).

The processing rules may include one or more actions or validations that are to be performed by the rule execution module 108c before the workflow processing system 112 is to execute the job. In some embodiments, each processing rule corresponds to a machine-readable rule record stored in a rule table, the rule record comprising a rule identifier, execution state indicator, dependency metadata, and execution constraints. The rule execution module 108c evaluates the rule records to perform atomic state transitions associated with the job prior to permitting job execution. In some embodiments, the one or more processing rules also include one or more actions that may include transmitting instructions to the workflow processing system 112 (e.g., to determine how a job is to be executed). In some embodiments, the one or more processing rules also include one or more actions that may execute (e.g., via the rule execution module 108c) after the job has been executed by the workflow processing system 112.

For example, a processing rule may be similar to a job, in which the processing rule is associated with at least one of instructions and input data, in which the instructions may cause the rule execution module 108c to process the input data according to a specific procedure, thereby generating output data (e.g., such as a change in the system’s state). In some embodiments, the one or more processing rules may be crucial in reducing or preventing inconsistencies in data that are to be processed by the corresponding job (e.g., a processing rule ensures that the amount of money in the sender’s bank account is enough to cover the amount of money being sent by the sender to the receiver).

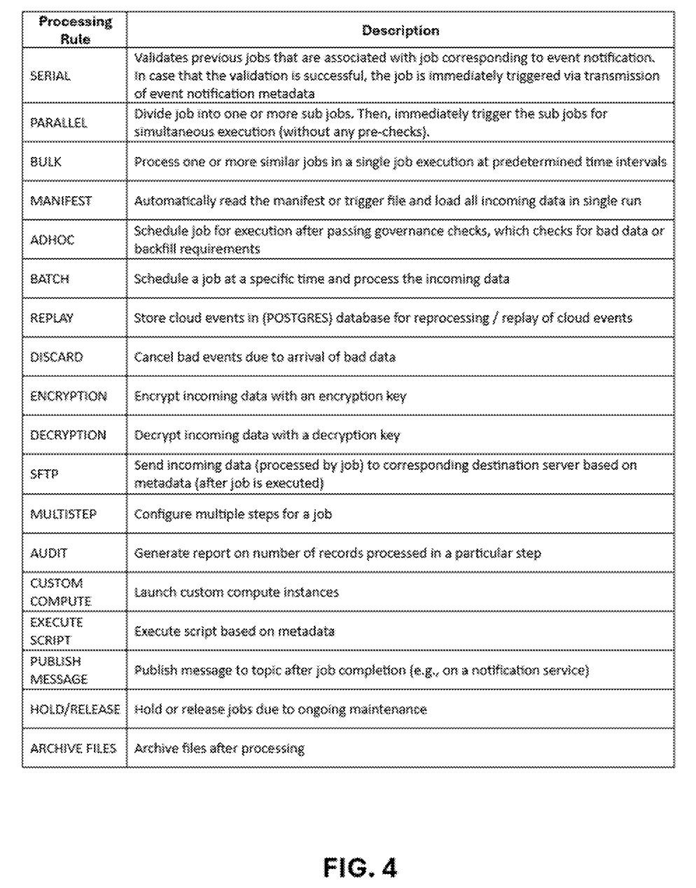

An example of the one or more processing rules is shown in table illustrated in FIG. 4. As shown in FIG. 4, the table includes one or more process rules that execute before the workflow processing system 112 is to execute the job (e.g., MANIFEST, ADHOC, BATCH, DISCARD, etc.), one or more processing rules that generated and/or transmit specific instructions to the workflow processing system 112 thereby causing the workflow processing system 112 to execute the job according to such instructions (e.g., SERIAL, PARALLEL, BULK, etc.), and one or more processing rules that execute after the workflow processing system 112 has already executed the job (e.g., SFTP, ARCHIVE FILES, etc.).

In some embodiments, each machine-readable rule record corresponds to a structured data object stored in a rule table or other persistent data store. Each rule record may include a rule identifier, a rule type indicator, one or more dependency identifiers identifying other rules or jobs that must be completed prior to execution, one or more execution constraints, and an execution state indicator.

The execution state indicator represents a current state of the corresponding processing rule and may include, for example, a pending state, an executing state, a completed state, or a failed state. Execution state transitions are persisted in memory or durable storage and are updated as rule evaluation progresses. In this manner, the rule execution module 108c maintains an explicit, machine-readable execution state model for each processing rule associated with a job.

For example, a serial processing (SERIAL) rule may determine whether the incoming data has successfully been processed by one or more previous jobs that are scheduled to execute before execution of the (current) job. The serial processing rule is successfully executed after determining that the one or more previous jobs have successfully processed the one or more incoming data. For example, in some embodiments, the job corresponding to the event notification may be dependent upon the completion of one or more associated jobs. More specifically, the one or more associated jobs may execute in sequence before the current job. Such sequence in execution may be crucial, for example, in cases in which the incoming data is to be processed (e.g., validated) or transformed into a specific format before being processed by the current job. Without performing such processing or transformation by the one or more associated jobs, the incoming data is incorrect / erroneous, and therefore the output from the current job may be incorrect as well (or in some cases, the current job may not be able to process the incoming data at all). Consequently, sequential processing of the incoming data ensures data integrity. The serial processing rule enforces a deterministic execution order across distributed compute instances based on timestamp and rule dependency metadata, in which the incoming data is sequentially processed by the job according to the timestamp.

In another example, a bulk processing (BULK) rule may cause the job to be executed along with other similar jobs that correspond to similar event notifications, in which the similar event notifications (or event notification metadata) are pending (e.g., persisting) in the event notification database 110. In other words, bulk execution of jobs may occur at scheduled predetermined time intervals (e.g., every one minute, five minutes, ten minutes, twenty minutes, etc.). Therefore, even though jobs associated with the bulk processing rule may have their corresponding processing rules executed completely, it does not necessarily mean that the job management module 108b is to transmit the event notification metadata to the workflow processing system 112 to execute the jobs. Instead, whenever the predetermined time interval is reached, the job management module 108b transmits the event notification metadata corresponding to each pending job (that is associated with the bulk processing rule) simultaneously to the workflow processing system 112, thereby causing the jobs (associated with the bulk processing rule) to be executed together simultaneously by the workflow processing system 112 (e.g., in a single execution and/or in the same compute instance). In some embodiments, even though there may be multiple pending jobs, the job management module 110b may select to transmit the event notification metadata specifically for jobs that have event notifications that are similar to each other. In some embodiments, the workflow processing system 112 may execute jobs that are similar to each other with respect to event notifications in a single execution and/or in the same compute instance.

In a further example, a parallel processing (PARALLEL) rule allows for jobs that are not dependent upon previous jobs to execute immediately. In other words, unlike jobs that are associated with, for example, the serial processing rule, the jobs associated with the parallel processing rule are capable of executing immediately (e.g., without performing any checks) due to the fact that such job is not dependent upon other jobs. For example, if the workflow processing system 112 receives one or more event notification metadata (that each corresponds to a parallel processing rule) simultaneously, the workflow processing system 112 can execute each of the corresponding jobs simultaneously, in which each job is executed on its own individual compute instance (described in infra). In some embodiments, the parallel processing (PARALLEL) rule may cause the job to be divided into one or more portions (e.g., sub jobs), in which each sub job is executed simultaneously. In some embodiments, each of the sub jobs may be executed in different compute instances. The parallel processing rule may be useful in cases in which execution of the job is not dependent on previous jobs. In another example, the transmission processing (e.g., SFTP, PUBLISH MESSAGE, etc.) rule causes incoming data processed by the job to be transmitted to a specific destination after the job has been successfully executed. In a further example, an encryption (ENCRYPTION) rule may cause incoming data to be encrypted, and a decryption (DECRYPTION) rule may cause at least one of the one or more incoming data to be decrypted. In yet a further example, a manifest processing (MANIFEST) rule may cause the manifest to be automatically read and/or trigger loading of all incoming data in single run (e.g., can be used for high frequency events, load the files from different storage buckets).

At block 310, the rule execution module 108c executes the one or more processing rules. At block 312, the event notification processing module 108a may transmit the event notification (or event notification metadata) in the event notification database 110 to cause execution of the corresponding job (e.g., by the workflow processing system 112). More specifically, after the rule execution module 108c has completed execution of the one or more processing rules, the rule execution module 108c may transmit a (rule execution completion) notification to the event notification processing module 108a that the one or more processing rules have completed execution. In response, the event notification processing module 108a may transmit the event notification (or event notification metadata) to the workflow processing system 112 to cause (or trigger) execution of the job. In some embodiments, the rule execution module 108c may transmit a notification to the job management module 108b that the one or more processing rules have completed execution. In turn the job management module 108b may instruct (or cause) the event notification processing module 108a to transmit the event notification (or event notification metadata) to the workflow processing system 112 to cause (or trigger) execution of the job.

It should be noted that not all of the one or more processing rules may be executed before transmission of the event notification (or event notification metadata) to the workflow processing system 112. In other words, as discussed previously, there may be one or more processing rules (e.g., SFTP, PUBLISH MESSAGE, ARCHIVE FILES, etc.) that correspond to actions that are to be taken after the (successful or unsuccessful) execution of a job. Therefore, in case that the one or more processing rules include a first set of processing rules that are configured to be executed before transmitting the event notification (or event notification metadata) to the workflow processing system 112 and a second set of processing rules that are configured to be executed after execution of the job, then the job management module 108b waits for the rule execution module 108c to successfully execute the first set of processing rules. After the first set of processing rules are successfully executed, the job management module 108b transmits the event notification (or event notification metadata) to the workflow processing system 112. After the workflow processing system 112 (successfully or unsuccessfully) executes the job, then the workflow processing system 112 may transmit the job execution status (discussed infra) to the rule execution module 108c, which then proceeds to execute the second set of processing rules.

In some embodiments, the rule execution module 108c executes the first set of processing rules and the second set of processing rules before the job management module 108b transmits the event notification (or event notification metadata) to the workflow processing system 112. More specifically, the rule execution module 108c may check whether the actions corresponding to the processing rules in the second set of processing rules are capable of being performed later (e.g., after execution of the job). For example, the rule execution module 108c may determine in the SFTP rule whether the destination server is available to transmit the incoming data that is processed by the job. After the rule execution module 108c determines that it is possible to perform the action specified by the processing rule, the rule execution module 108c may determine that the processing rule has been successfully completed or executed. Therefore, after the workflow processing system 112 (successfully or unsuccessfully) executes the job, then the workflow processing system 112 may transmit the job execution status (discussed infra) to the rule execution module 108c, which then proceeds to execute the actions corresponding to the second set of processing rules.

At block 314, the workflow processing system 112 generates a compute instance for executing the job. The compute instance is instantiated as an isolated execution environment without shared persistent state, thereby preventing interference between concurrently executing jobs. A compute instance may be on a single physical machine that is capable of executing code (e.g., corresponding to applications). In some embodiments, a compute instance may include a virtual machine instance that can emulate a virtual hardware layer (e.g., processor, RAM, storage, network interfaces, graphic cards, etc.) as well as an operating system (e.g., Windows, OS X, Unix, Linux, etc.). In other embodiments, the compute instance may include a container which are lightweight executable images that hold application code and its dependencies. More specifically, containers are logical units created within a virtual machine instance, or on a host computing device, using the resources available on that instance or device. For example, each container may provide a file system isolated from other file systems on the device, and code executing in the container may have limited or no access to other file systems or memory space associated with code executing outside of the container.

In some embodiments, it is possible for a computing device (e.g., client computing device) or a cloud platform (e.g., cloud platform 106) to run on a plurality of compute instances (e.g., virtual machine instances or containers). Consequently, each of the virtual machine instances may share the same physical hardware and each of the containers may share the same physical hardware and the same operating system (or variants of the same operating system, different operating systems, or combinations thereof). It should be noted that even though both virtual machine instances and containers share certain resources with each other, virtual machine instances and containers are isolated from each other, thereby allowing for multiple isolated environments to be running on a single physical machine.

In some embodiments, the compute instance may be a pod, which may be the smallest deployable unit of computation in, for example, Kubernetes. More specifically, a pod may include a collection of one or more containers that share one or more resources (e.g., processing power, storage, networking, etc.) with each other. In other words, because the one or more containers may also share the same network namespace and storage volumes, the one or more containers within the pods are allowed to communicate and share data with each other, thereby allowing the one or more containers in the pod to act or run as a single unit.

At block 316, the workflow processing system 112 executes the job. At block 318, the workflow processing system 112 terminates the compute instance. The immediate termination of the compute instance releases compute, memory, and network resources and prevents residual state from affecting subsequent job executions. In some embodiments, such termination may include stopping the compute instance (but not removing or deleting it). In some embodiments, such termination may include stopping and removing (e.g., deleting) the compute instance. At block 322, the workflow processing system 112 transmits the status of the job execution. For example, as discussed previously, the job status may correspond to successful or unsuccessful job execution.

In some embodiments, the workflow processing system 112 may transmit the job status via a user interface (e.g., to be displayed on a screen of the client computing device 102). In some embodiments, the workflow processing system 112 may record the job status in a log. In some embodiments, the workflow processing system 112 may transmit the job execution status to the event notification processing module 108a (e.g., after the job has successfully been executed), which then marks the event notification as complete in the event notification database 110. In some embodiments, as discussed previously, the workflow processing system 112 may transmit the job execution status to the rule execution module 108c which, in turn, may execute the one or more processing rules that are configured to execute after execution of the job (e.g., SFTP, PUBLISH MESSAGE, ARCHIVE FILES, etc.). At block 322, the routine ends.

In some embodiments, when execution of a job fails, the workflow processing system 112 transmits a failure status to the event orchestration system 108, which records a failed execution state in the event notification database 110. Automatic re-execution of the job is suppressed to prevent repeated execution based on stale or inconsistent system state.

Subsequent event notifications corresponding to the same job are evaluated in view of the recorded execution state to determine whether execution should be deferred, rejected, or require manual intervention. By explicitly recording and enforcing failure states, the system prevents cascading failures and ensures that subsequent job execution decisions are made based on a consistent and durable representation of system state.

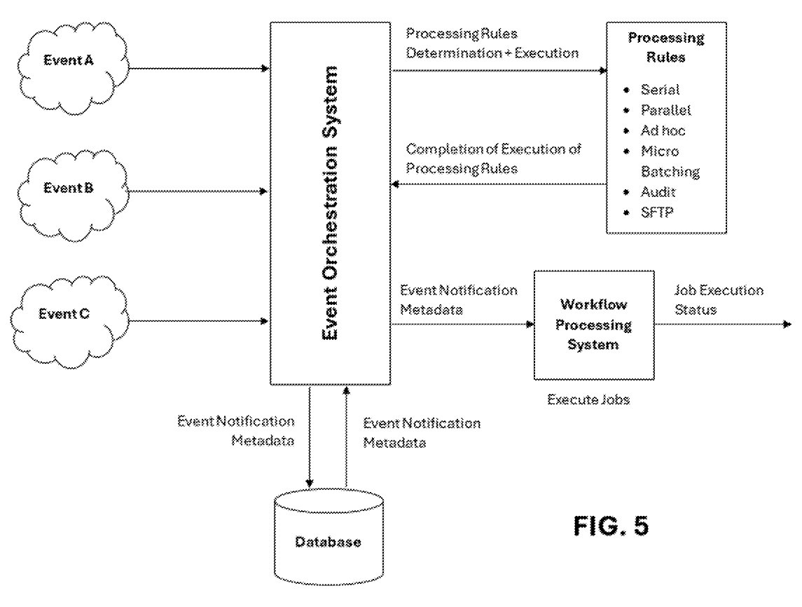

It should also be noted that the process in FIG. 3 is also illustrated in FIG. 5 (with slight modifications) that may be implemented in some embodiments. As shown in FIG. 5, one or more event notifications (e.g., event notification A, event notification B, event notification C, etc.) may be received by an event orchestration system. For example, the event notifications may be generated by a cloud platform after an event has occurred. In turn, the event orchestration system may extract an event notification metadata from the event notification and may store such extracted event notification metadata into a database. In other words, each of the event notifications A, B, and C may include corresponding event notification metadata (which is extracted and stored in the database).

The event orchestration system then determines, based on the event notification data, a job and one or more processing rules. The event orchestration system then executes each of the one or more processing rules. After the event orchestration system has completed successful execution of each of the one or more processing rules, the event orchestration system retrieves the event notification metadata from the database. The event orchestration system then transmits the event notification metadata to the workflow processing system. In turn, the workflow processing system executes the job. After executing the job, the workflow processing system may transmit a job execution status (e.g., successfully executed or failed).

In some embodiments, the orchestration process guarantees that each non-replayable event notification results in at most one job execution. Duplicate event notifications corresponding to a same cloud event are detected and suppressed using the event notification database 110, thereby enforcing idempotent job execution.

In addition, execution ordering enforced by serial processing rules ensures that dependent jobs are executed in a deterministic sequence that is independent of the order in which event notifications are received. Together, idempotent execution and deterministic ordering provide consistency guarantees across distributed computing resources, even in the presence of concurrent event delivery and partial system failures.

It should be noted that the aforementioned approach allows for instantaneous synchronization. In other words, users are not required to wait a specific amount of time before their data can be updated to the most recent version (e.g., a merchant does not need to wait until the payment is complete in order to use the corresponding money to purchase products for inventory). To facilitate such instantaneous synchronization, such approach utilizes a cloud platform, which generates updates in the form of cloud events (e.g., event notifications) in real-time (e.g., in under 100 milliseconds [ms]), thus enabling updates from the cloud instantaneously (e.g., with little or no perceptible delay to an end user).

Second, the cloud events (e.g., event notifications) that are received from the cloud platform are immediately captured, processed (e.g., metadata extraction), and stored in a database (e.g., event notification database 110). As discussed previously, the cloud events may be generated a single time, such that it may be impossible to obtain such cloud events again if not captured in time. Therefore, storing such cloud events is crucial to ensuring that the cloud events are not lost. Further, the one or more processing rules are immediately determined from the capture cloud event. The one or more processing rules associated with the cloud event (e.g., event notification) and the job allow for ensuring data consistency and data integrity with respect to incoming data (e.g., input data) when executing jobs. In other words, the immediate processing of the cloud event as well as executing the one or more processing rules to ensure data integrity and consistency allow for instantaneous synchronization. Consequently, users are not forced to wait for updates to happen.

### Example Routine for Processing Serial Rule

When a routine described herein (i.e., 300 and 600) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 700 shown in FIG. 7, and executed by one or more processors. In some embodiments, the routine 300 and 600, or portions thereof may be implemented on multiple processors, serially or in parallel.

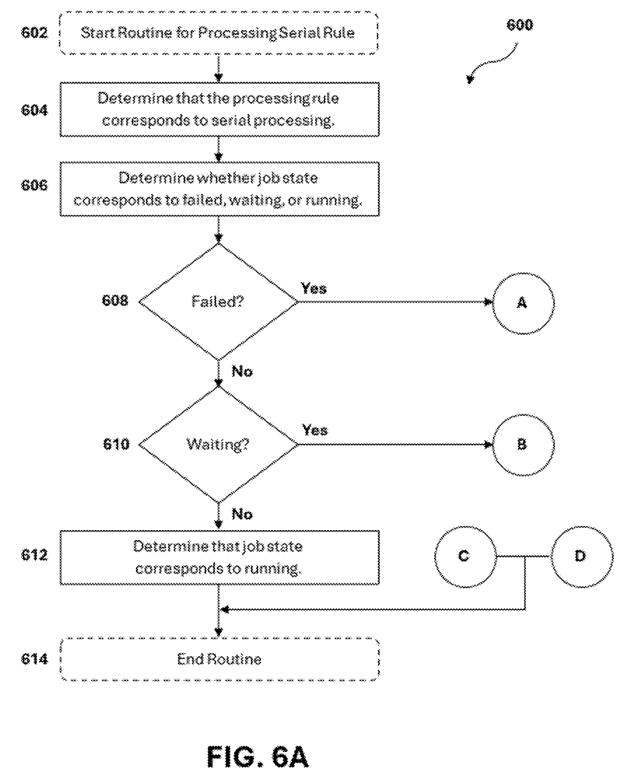

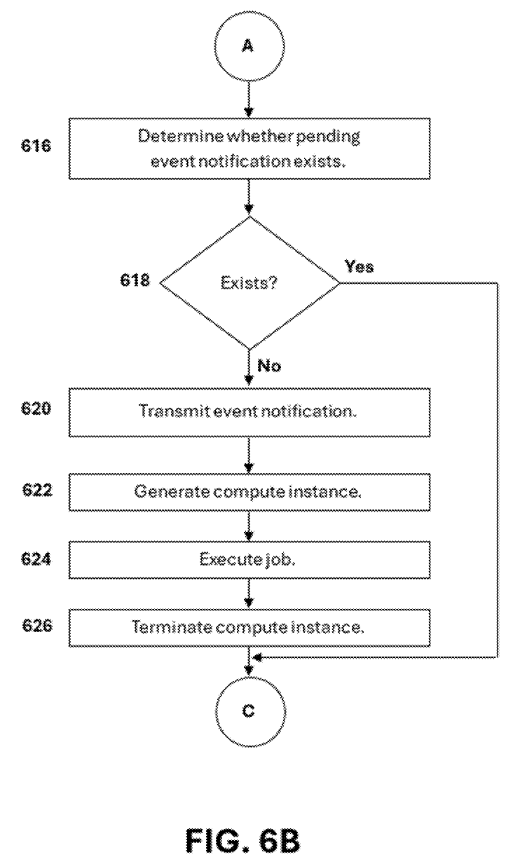

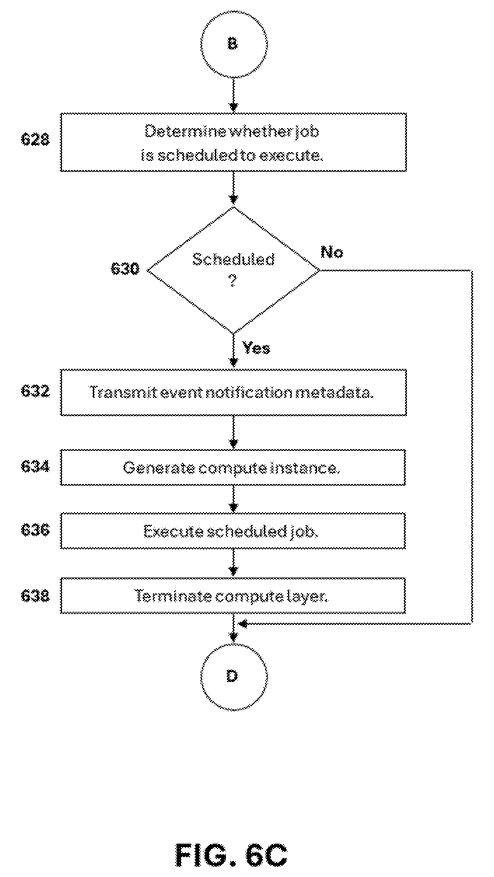

FIGS. 6A-6C illustrate example routine 600 (beginning at block 602) for processing a serial processing rule, that is performed, for example, by at least one of the event orchestration system 108, the event notification database 110, and the workflow processing system 112. As discussed previously, the serial processing (SERIAL) rule may determine whether incoming data has successfully been processed by one or more previous jobs that are scheduled to execute before execution of the (current) job. However, the routine 600 may also provide additional (or substituted) actions that correspond to the serial processing rule. In other words, the additional (or substituted) actions may be performed when processing the serial processing rule as well.

At block 602, the event orchestration system 108 (or the job management module 108b) may determine that the processing rule corresponds to serial processing. For example, the job management module 108b may make such determination after receiving (and storing) an event notification from the cloud platform 106 and determining the job and the processing rule corresponding to event notification (e.g., blocks 304 to 306 in routine 300 in FIG. 3). More specifically, the job management module 108b may utilize an event notification metadata of the event notification to determine the corresponding job and processing rules.

At block 606, the job management module 108b determines whether a job state corresponds to failed, waiting, or running. More specifically, the job state may correspond to the job that is associated with the event notification metadata. For example, it is possible that a job may correspond to two or more (e.g., a plurality of) event notifications. Likewise, in another example, it is possible that a single event notification may correspond to two or more (e.g., a plurality of) jobs. In the case that the job state corresponds to failed, it may be that a prior or previous event notification (e.g., received from the cloud platform 106) caused or triggered the same job to be executed on the workflow processing system 112. However, the workflow processing system 112 failed to execute the job.

In the case that the job state corresponds to waiting, it may be that a job is placed on a schedule for execution on the workflow processing system 112. More specifically, in some embodiments, after event notification is received by the event orchestration system 108, the job management module 108b may transmit a job notification to the workflow processing system 112, in which the workflow processing system 112 may schedule a job for execution (i.e., the job executes when the workflow processing system 112 receives the corresponding event notification metadata). In a further example, in case that the job state corresponds to running, it may be that a prior or previous event notification (e.g., received from the cloud platform 106) caused or triggered the same job to execute. As such, the same job may be being executed by the workflow processing system 112.

Consequently, in case that the job state corresponds to failed (block 608, yes), the routine 600 moves to block 616, which is shown in FIG. 6B. At block 616, the job management module 108b determines whether any pending event notifications exist. In other words, there may be an event notification that was previously received from the cloud platform 106 that is pending. More specifically, a first event notification may be received (e.g., from cloud platform 106) by the event orchestration system 108. The job management module 108b may determine a specific job and one or more specific processing rules (e.g., include serial processing rule) that correspond to the first event notification (e.g., the determination being made based on a previous event notification metadata). It should be noted that the specific job corresponds to the failed job that the workflow processing system 112 failed to execute. After the rule execution module 108c has successfully executed the one or more processing rules, the job management module 108b may transmit the first event notification metadata to the workflow processing system 112 to cause execution of the specific job. However, the workflow processing system 112 may have failed to execute the specific job (e.g., due to one or more errors). In some embodiments, the workflow processing system 112 does not attempt (e.g., retry) to execute again a job that has failed.

After an indeterminate time period, a second event notification may be received by the event orchestration system 108. The second event notification may be associated with the (same) specific job and (the same or different) one or more processing rules (including serial processing rule) as the first event notification. As discussed previously, after the one or more processing rules (corresponding to the second event notification) are determined, the rule execution module 108c executes the one or more processing rules. As such, the second event notification is pending until the rule execution module 108c finishes executing each of the one or more processing rules.

Consequently, in the case that there exists a pending event notification (e.g., second event notification) as determined by the job management module 108b (block 618, yes), the routine 600 moves to block 614. On the other hand, in the case that there is no pending event notification (e.g., second event notification) as determined by the job management module 108b (block 618, yes), the routine 600 moves to block 620. At block 620, the job management module 108b transmits the event notification to the workflow processing system 112. In some embodiments, the rule execution module 108c may transmit a notification to the job management module 108b that the one or more processing rules (including serial processing rule) have completed execution. In turn the job management module 108b may instruct (or cause) the event notification processing module 108a to transmit the event notification to the workflow processing system 112 to cause (or trigger) execution of the job.

At block 622, the workflow processing system 112 generates a compute instance for executing the job. A compute instance may be an isolated environment on a single physical machine that is capable of executing code (e.g., corresponding to applications). In some embodiments, a compute instance may include a virtual machine instance that can emulate a virtual hardware layer (e.g., processor, RAM, storage, network interfaces, graphic cards, etc.) as well as an operating system (e.g., Windows, OS X, Unix, Linux, etc.). In other embodiments, the compute instance may include a container which are lightweight executable images that hold application code and its dependencies. More specifically, containers are logical units created within a virtual machine instance, or on a host computing device, using the resources available on that instance or device. For example, each container may provide a file system isolated from other file systems on the device, and code executing in the container may have limited or no access to other file systems or memory space associated with code executing outside of the container.

At block 624, the workflow processing system 112 executes the job. At block 626, the workflow processing system 112 terminates the compute instance. In other words, after the job has been executed (e.g., whether successfully or unsuccessfully), the workflow processing system 112 may terminate the compute instance. In some embodiments, such termination may include stopping the compute instance (but not removing or deleting it). In some embodiments, such termination may include stopping and removing (e.g., deleting) the compute instance. After block 624 has been executed, the routine 600 moves to block 614.

In the event that the job state does not correspond to ‘failed’ (block 608, no), the routine 600 moves to block 610. At block 610, the job management module 108b determines whether the job state corresponds to ‘waiting.’ In the event that the job state corresponds to ‘waiting’ (block 610, yes), the routine 600 moves to block 628, which is shown in FIG. 6C. At block 628, the job management module 108b determines whether the job is scheduled to execute. For example, in some embodiments, a job may be placed on a schedule for execution on the workflow processing system 112. More specifically, in some embodiments, after the event notification is received by the event orchestration system 108, the job management module 108b may transmit a job notification to the workflow processing system 112, in which the workflow processing system 112 may schedule a job for execution. Consequently, the job is executed (e.g., immediately) when the workflow processing system 112 receives the corresponding event notification metadata.

Therefore, in case that the job has not been scheduled (block 630, no), the routine 600 moves to block 614. On the other hand, in the case that the job has been scheduled (block 630, yes). At block 632, the job management module 108b transmits the event notification to the workflow processing system 112. In some embodiments, the rule execution module 108c may transmit an event notification to the job management module 108b that the one or more processing rules (including serial processing rule) have completed execution. In turn, the job management module 108b may instruct (or cause) the event notification processing module 108a to transmit the event notification to the workflow processing system 112 to cause (or trigger) execution of the job.

At block 634, the workflow processing system 112 generates a compute instance for executing the job. A compute instance may be an isolated environment on a single physical machine that is capable of executing code (e.g., corresponding to applications). In some embodiments, a compute instance may include a virtual machine instance that can emulate a virtual hardware layer (e.g., processor, RAM, storage, network interfaces, graphic cards, etc.) as well as an operating system (e.g., Windows, OS X, Unix, Linux, etc.). In other embodiments, the compute instance may include a container which are lightweight executable images that hold application code and its dependencies. More specifically, containers are logical units created within a virtual machine instance, or on a host computing device, using the resources available on that instance or device. For example, each container may provide a file system isolated from other file systems on the device, and code executing in the container may have limited or no access to other file systems or memory space associated with code executing outside of the container.

At block 636, the workflow processing system 112 executes the job. At block 638, the workflow processing system 112 terminates the compute instance. In other words, after the job has been executed (e.g., whether successfully or unsuccessfully), the workflow processing system 112 may terminate the compute instance. In some embodiments, such termination may include stopping the compute instance (but not removing or deleting it). In some embodiments, such termination may include stopping and removing (e.g., deleting) the compute instance. After block 638 has been executed, the routine 600 moves to block 614.

In the event that the job state does not correspond to ‘waiting’ (block 610, no), the routine 600 moves to block 612. At block 612, the job management module 108b determines that the job state corresponds to ‘running.’ In other words, the job corresponding to the event notification may currently be executing due to a previous event notification. For example, a first event notification may cause a job to be executing on the workflow processing system 112. However, a second event notification may be received, in which such second event notification may correspond to the same job as the first event notification. Further, the one or more processing rules may have completed while the job corresponding to the first event notification is executing. Therefore, the job management module 108b does not transmit the event notification metadata to the workflow processing system 112 (e.g., because the job management module 108b determines that the job corresponds to a serial processing rule). At block 614, the routine ends.

In some embodiments, execution of a job on a compute instance is subject to one or more resource constraints, including limits on execution duration, memory usage, and processor allocation. Upon termination of the compute instance, allocated resources are reclaimed by the cloud platform, thereby preventing resource starvation and ensuring predictable system performance under high event throughput.

### Execution Environment

FIG. 7 illustrates various components of an example computing device 700 configured to implement various functionality described herein.

In some embodiments, the computing device 700 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the computing device 700 may be implemented as web services consumable via one or more communication networks. In further embodiments, the computing device 700 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 700 may include one or more processors 702, such as physical central processing units (“CPUs”); one or more network interfaces 704, such as network interface cards (“NICs”); one or more computer readable medium drives 706, such as a high density disk (“HDDs”), solid state drives (“SSDs”), flash drives, and/or other persistent computer readable media; one or more input/output drive interfaces 708; and one or more computer-readable memories 710, such as random access memory (“RAM”) and/or other volatile non-transitory readable media.

The one or more computer-readable memories 710 may include computer program instructions that one or more computer processors 702 execute and/or data that the one or more computer processors 702 use in order to implement one or more embodiment. For example, the one or more computer-readable memories 710 can store an operating system 712 to provide general administration of the computing device 700. As another example, the one or more computer-readable memories 710 can store an event orchestration system 714 (e.g., event orchestration system 108) to orchestrate job executions based on event notifications received from a cloud platform (e.g., cloud platform 106). The event orchestration system 714 may store an event notification processing module 714 (e.g., event notification processing module 108a) for processing event notifications received from a cloud platform (e.g., cloud platform 106), a job management module 718 (e.g., job management module 108b) for determining jobs and processing rules associated with received event notifications, and a rule execution module 720 (e.g., rule execution module 108c) for executing one or more processing rules. In a further example, the one or more computer-readable memories 710 can store a workflow processing system 722 (e.g., workflow processing system 112) for executing jobs.

The above-described techniques may be implemented in digital or analog electronic circuitry, or in computer hardware, firmware, software, or combinations thereof. In some embodiments, the techniques are implemented as one or more computer programs embodied in one or more non-transitory, machine-readable storage media and executable by one or more processors to control operation of a computing system. The computer programs may be written in any suitable programming language and may be deployed in any suitable form, including as stand-alone programs, modules, services, or components within a distributed computing environment. In some embodiments, execution is event-driven and responsive to discrete input events generated by external systems.

Method steps described herein may be performed by one or more processors executing stored instructions, or by special-purpose logic circuitry, including programmable or reconfigurable logic devices such as FPGAs, CPLDs, application-specific instruction-set processors (ASIPs), system-on-chip devices, or application-specific integrated circuits (ASICs). The processors may be single-core, multi-core, or distributed across multiple computing nodes.

Processors may receive instructions and data from one or more memory devices, including volatile and non-volatile memory. Memory devices may include local memory, cache memory, distributed memory, or network-attached storage. Storage media may include semiconductor memory devices, magnetic storage devices, optical storage devices, or other suitable storage technologies. In distributed implementations, execution state and data may be persisted across multiple storage systems to support fault tolerance and consistency.

In some embodiments, the techniques may be implemented in systems that include user interaction components, such as displays, input devices, or other interfaces. In other embodiments, the techniques operate without direct user interaction, such as in server-side, service-to-service, or automated execution environments.

The techniques may be implemented in distributed computing systems that include one or more back-end components, middleware components, and front-end components, which may communicate through application programming interfaces (APIs), message-based communication, or other inter-process communication mechanisms. Components may be deployed across multiple physical or virtual computing environments, including cloud computing platforms.

In some embodiments, one or more components of the disclosed systems and methods are executed within virtualized execution environments, including virtual machines, containers, or other forms of isolated runtime environments. Containerized implementations may package executable code together with associated libraries, dependencies, and configuration data, enabling consistent execution across heterogeneous computing infrastructures. Such containerized execution environments may be instantiated dynamically and terminated upon completion of execution to provide isolation, portability, and efficient resource utilization.

In some embodiments, execution of jobs, compute instances, or containers is coordinated by an orchestration platform that manages lifecycle events, resource allocation, scheduling, and termination of execution environments. The orchestration platform may monitor system state, enforce execution constraints, and allocate compute, memory, and network resources across multiple execution units. Orchestration platforms may include container orchestration systems, virtual machine managers, or other distributed resource management frameworks.

In distributed implementations, execution state, rule state, event metadata, and job status information may be stored in one or more distributed state stores that provide durability, consistency, and fault tolerance across computing nodes. Such state stores may include databases, key-value stores, log-based storage systems, or other persistent data services. State information may be replicated, versioned, or otherwise coordinated across multiple storage systems to support concurrent execution, failure recovery, and deterministic system behavior.

In some embodiments, execution of system components is event-driven, such that receipt of an event notification, message, or signal triggers evaluation of execution rules and initiation of job execution. Event-driven execution may be asynchronous and decoupled from the source of the event, allowing the system to respond to events generated by external services, cloud platforms, or internal components without requiring synchronous coordination. Event notifications may be transient or non-replayable, and system operation may be structured to ensure reliable processing of such events despite asynchronous delivery and potential failures.

In some embodiments, event-driven execution is coordinated with distributed execution state to ensure that jobs are executed in accordance with defined ordering, dependency, and idempotency constraints. Evaluation of execution rules may be performed using persisted state information rather than relying on in-memory coordination or timing-based assumptions. This coordination enables consistent system behavior in the presence of concurrent event delivery, partial execution failures, or dynamic scaling of execution resources.

Components of the computing system may communicate over one or more transmission media using packet-based or circuit-based communication networks. Communication may occur using wired or wireless protocols, including Internet Protocol–based networking, local or wide area networking, and other suitable communication technologies.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

In some embodiments, the techniques may incorporate machine learning or supervised learning algorithms, including models trained using labeled data to generate outputs based on input data. Such algorithms may be used to inform decision-making, rule evaluation, or other system operations, and are optional and non-limiting with respect to the disclosed embodiments.

As used herein, the terms “comprise,” “include,” and plural forms thereof are open-ended and include the listed elements as well as additional elements not expressly listed. The term “and/or” is open-ended and includes one or more of the listed elements and combinations thereof.

The described embodiments are illustrative and not restrictive. Variations and modifications may be made without departing from the spirit or scope of the disclosure, as will be understood by those skilled in the art.

What is claimed is:

1. A computing system for orchestrating jobs on a cloud platform, the system comprising memory for storing computer-executable instructions and a processor that executes the computer-executable instructions to:
capture an event notification that is transmitted by the cloud platform after a specific event has occurred in the cloud platform, wherein the event notification is stored in an event notification database after being captured, wherein the event notification is non-replayable and generated a single time by the cloud platform, and wherein the event notification includes event notification metadata;
determine a job corresponding to the event notification and one or more processing rules associated with the job based on the event notification metadata, wherein the one or more processing rules determine a manner in which to execute the job, and wherein the one or more processing rules include one or more processing actions that are performed before and after execution of the job;
execute the one or more processing rules by evaluating machine-readable rule records that define execution dependencies and execution state transitions for the job;
trigger the job for execution, after determining that each of the one or more processing rules has been successfully executed, by retrieving the event notification metadata from the event notification database; and
execute the job on a compute instance that is generated specifically for the job, the compute instance being instantiated without shared persistent state and isolated from other compute instances, wherein the compute instance is terminated immediately after completion of the job execution to release compute resources and prevent cross-job interference.

2. The computing system of claim 1, wherein execution of the job comprises processing one or more incoming data, and wherein the job includes one or more processing actions that process the one or more incoming data.

3. The computing system of claim 2, wherein the one or more processing rules associated with the job include at least one of:
(i) an encryption processing rule that causes at least one of the one or more incoming data to be encrypted, and
(ii) a decryption processing rule that causes at least one of the one or more incoming data to be decrypted.

4. The computing system of claim 2, wherein the one or more processing rules associated with the job include a serial processing rule that determines whether the one or more incoming data has successfully been processed by one or more previous jobs that are scheduled to execute before the job, and wherein the serial processing rule is successfully executed after determining that the one or more previous jobs have successfully processed the one or more incoming data.

5. The computing system of claim 4, wherein each of the one or more incoming data is associated with a timestamp, and wherein, when the one or more processing rules include the serial processing rule, each of the one or more incoming data is sequentially processed by the job according to the timestamp.

6. The computing system of claim 1, wherein the one or more processing rules associated with the job include a parallel processing rule that causes the job to be executed immediately after retrieval of the event notification metadata from the event notification database.

7. The computing system of claim 1, wherein the one or more processing rules associated with the job include a bulk processing rule that causes the job to be scheduled to execute simultaneously with one or more other jobs that each correspond to the bulk processing rule, and wherein the job and the one or more other jobs are executed within a same compute instance.

8. The computing system of claim 7, wherein the bulk processing rule causes jobs to be processed at predetermined time intervals.

9. The computing system of claim 1, wherein the one or more processing rules associated with the job include a transmission processing rule that causes the job data processed by the job to be transmitted to a specific destination after the job has been successfully executed.

10. The computing system of claim 1, wherein the server computing device detects and suppresses duplicate event notifications corresponding to a same cloud event using the event notification database.

11. The computing system of claim 1, wherein the server computing device marks the event notification as completed in the event notification database after the job has successfully been executed.

12. The computing system of claim 1, wherein the server computing device performs execution state transitions defined by the machine-readable rule records atomically to prevent inconsistent job execution states.

13. A computerized method for orchestrating jobs on a cloud platform, the method comprising:
capturing, by a server computing device, an event notification that is transmitted by the cloud platform after a specific event has occurred in the cloud platform, wherein the event notification is non-replayable and generated a single time by the cloud platform, and wherein the event notification is stored in an event notification database after being captured, the event notification including event notification metadata;
determining, by the server computing device, a job corresponding to the event notification and one or more processing rules associated with the job based on the event notification metadata, wherein the one or more processing rules determine a manner in which to execute the job, and wherein the one or more processing rules include one or more processing actions that are performed before and after execution of the job;
executing, by the server computing device, the one or more processing rules by evaluating machine-readable rule records that define execution dependencies and execution state transitions for the job;
triggering, by the server computing device, the job for execution, after determining that each of the one or more processing rules has been successfully executed, by retrieving the event notification metadata from the event notification database; and
executing, by the server computing device, the job on a compute instance that is generated specifically for the job, the compute instance being instantiated without shared persistent state and isolated from other compute instances, wherein the compute instance is terminated immediately after completion of the job execution to release compute resources and prevent cross-job interference.

14. The computerized method of claim 13, wherein execution of the job comprises processing one or more incoming data, and wherein the job includes one or more processing actions that process the one or more incoming data.

15. The computerized method of claim 14, wherein the one or more processing rules associated with the job include at least one of:
(i) an encryption processing rule that causes at least one of the one or more incoming data to be encrypted, and
(ii) a decryption processing rule that causes at least one of the one or more incoming data to be decrypted.

16. The computerized method of claim 14, wherein the one or more processing rules associated with the job include a serial processing rule that determines whether the one or more incoming data has successfully been processed by one or more previous jobs that are scheduled to execute before the job, and wherein the serial processing rule is successfully executed after determining that the one or more previous jobs have successfully processed the one or more incoming data.

17. The computerized method of claim 16, wherein each of the one or more incoming data is associated with a timestamp, and when the one or more processing rules include the serial processing rule, each of the one or more incoming data is sequentially processed by the job according to the timestamp.

18. The computerized method of claim 13, wherein the one or more processing rules associated with the job include a parallel processing rule that causes the job to be executed immediately after retrieval of the event notification metadata from the event notification database.

19. The computerized method of claim 13, wherein the one or more processing rules associated with the job include a bulk processing rule that causes the job to be scheduled to execute simultaneously with one or more other jobs that each correspond to the bulk processing rule, and wherein the job and the one or more other jobs are executed within a same compute instance.

20. The computerized method of claim 19, wherein the bulk processing rule causes jobs to be processed at predetermined time intervals.

21. The computerized method of claim 13, wherein the one or more processing rules associated with the job include a transmission processing rule that causes the job data processed by the job to be transmitted to a specific destination after the job has been successfully executed.

22. The computerized method of claim 13, further comprising detecting and suppressing duplicate event notifications corresponding to a same cloud event.

23. The computerized method of claim 13, wherein the event notification is marked completed in the event notification database after the job has successfully been executed.

24. The computerized method of claim 13, wherein executing the one or more processing rules comprises performing atomic execution state transitions to prevent partial execution of the job.
